(19) United States
(12) Patent Application Publication
(10) Pub. No.: US 2022/0213725 A1
(43) Pub. Date: Jul. 7, 2022

(54) FURNITURE ITEM WITH A LEAF

(71) Applicant: BORTOLUZZI SISTEMI S.P.A., Belluno (IT)

(72) Inventors: Rudy DAL CASTEL, Belluno (IT); Adriano GIROTTO, Belluno (IT); Daniele SBARDELLA, Belluno (IT); Angelo IRRERA, Belluno (IT)

(21) Appl. No.: 17/440,804

(22) PCT Filed: Mar. 26, 2020
(86) PCT No.: PCT/IB2020/052845

§ 371 Date: Sep. 20, 2021

(30) Foreign Application Priority Data
Mar. 27, 2019 (IT) 102019000004555

(51) Int. Cl. E05D 15/04; E05D 15/26

(52) U.S. Cl. CPC E05D 15/04; E05Y 2900/20; E05D 15/26

(57) ABSTRACT

A method is described for building a furniture item (MC) that—in use—comprises a leaf (30, 32), a linear downwards-inclined guide (230), and a body (200) slidably mounted on the guide (230) and connected to the leaf (30, 32) to drag it to an end-of-travel position, wherein said body (200) moves on the guide (230) to drag the leaf only thanks to the force of gravity.

The invention relates to a furniture item, in particular with sliding and swinging leaves so as to be foldaway leaves, more particularly equipped with a compartment closable thanks to the leaves. The invention also relates to a method for said piece of furniture.

Many furniture items are equipped with sliding and folding leaves to allow a reduction of the dimensions of the leaves themselves in the open position, see e.g. WO2019012435. WO2019012435, like many other models, implements an elastic element to move the skids 210 (ibidem) and bring the leaf to an end-of-stroke position. However, the elastic element complicates the structure, costs and generates a not very linear force.

Improving this state of the art is the main object of the invention, which is defined in the appended claims, in which the dependent ones define advantageous variants.

Another object is to create a piece of furniture having a compartment that can be closed by sliding and bellows-like foldable leaves, which is easy to operate, requires few movements for the user and is not too tiring during use.

A method is proposed to build a piece of furniture that—in use—comprises

a leaf,

a linear guide which is inclined downwards,

a body slidingly mounted on the guide and connected to the leaf to drag it to an end-of-travel position,

wherein said body moves on the guide to drag the leaf only thanks to the force of gravity.

Another aspect of the invention relates to a furniture item comprising in use:

a (vertical or horizontal) leaf that is slidable and swinging to close a compartment,

a linear guide which is inclined downwards;

a body slidingly mounted on the guide and connected to the leaf to drag it to an end-of-travel position;

wherein said body is configured to be able to move on the guide to drag the leaf towards an end-of-travel position only thanks to the force of gravity.

In a preferred variant, the body is slidably mounted on two parallel tilted-down guides, for better stability.

In a preferred variant, the body is slidably mounted on the guide—or on the guides—by means of skids, so as to move slantwise when the skids slide on the guide or guides.

In a preferred variant, the body has such a weight as to—or a weight sufficient to—make it slide on the guide to drag the leaf only thanks to the force of gravity. The force of gravity, however, can act not only on the body to make it slide on the guide but also on other elements integral with the body, e.g. on at least one skid that slidingly supports the body on the guide or guides.

In a preferred application, the method is carried out on a furniture item comprising:
a body that defines a compartment with a front opening,
a (vertical or horizontal) door that is slidable and swinging to close the front opening,
an L-shaped guide comprising two linear segments joined together, wherein

a first segment is parallel to an edge of the opening, and

a second segment is orthogonal to the first segment and arranged in correspondence of an external side of the body along the depth direction of the compartment;
a control element that can be translated parallel to—and along—said external side;
wherein

a side edge of the leaf is slidingly coupled to the L-shaped guide, and

the opposite side edge of the leaf is swingingly connected to the control element so that a linear reciprocating motion of the latter moves the leaf to a first position in which it closes the opening or to a second position in which the leaf clears the opening and is placed next to said external side, wherein

the control element coincides with the aforementioned slidingly mounted body or

the control element is connected to the aforementioned slidingly mounted body to be moved in order to displace the leaf to the first or second position.

According to a variant, the furniture item comprises a first leaf as defined above and a second leaf connected to the first leaf in an oscillating way (e.g. they are hinged to each other). The first leaf, at its side closest to the second segment, is slidingly coupled to the guide. One side of the first leaf is hinged to the translatable control element about a first axis. The opposite side of the first leaf is slidably coupled to the guide, in particular it may be hinged about a second axis to the second leaf. When the first leaf is not directly coupled to the guide, it is through the second leaf. However, the translatable control element can thus operate the leaf train transmitting kinetic energy to them through its own translational reciprocating movement, a movement that develops parallel to the depth direction of the compartment.

It therefore turns out that the leaves can be folded bellows-like about at least one axis, and they are slidable between a closed position of the compartment, in which they are arranged coplanar with each other in front of the compartment, and an opening position of the compartment, in which they are folded one over the other and placed along said side of the compartment.

The leaves are conveniently set in motion by a reciprocating movement of the translatable control element.

In other words, the control element can be moved between two positions:

a rest position in which it is placed in front of the external side (flank) and substantially does not protrude frontally therefrom, and

a position in which it is offset horizontally with respect to the external side (and to the compartment) to protrude frontally from the external side and from the compartment (the translatable command element is moved to the direction of the front opening of the compartment and is moved away from the back of the compartment).

The leaves are conveniently set in motion by a reciprocating movement of the translatable control element.

Said external side of the compartment may be a side or a ceiling or a bottom.

Thus one or more leaves can be hidden next to the compartment, above the compartment or below it. In the first case, the L-shaped guide has both segments positioned horizontally; while in the second case the first segment is horizontal and the second segment is vertical. That is to say, the aforementioned variants with one or two leaves in turn can be implemented through leaves assembled to move horizontally or vertically.

In the first case the abovementioned axes are vertical, in the second case they are horizontal. Below, for sake of simplicity, we will refer to the case of horizontally hinged leaves, it being understood that the second case corresponds to the first mutatis mutandis.

The first hinge axis is supported by the translatable control element so that it can rigidly translate horizontally. Thus, such first axis is movable horizontally between two extremes: a rest extreme and an advanced extreme (more distant from the compartment). To a reciprocating motion of the translatable command element there corresponds both a movement of the first axis, which always starts from the first extreme, arrives at the second one, and returns again to the first; and a displacement of the second axis along the guide. This shift of the second axis along the guide occurs along one direction and then along the opposite direction during two subsequent reciprocating motions of the translatable control element. At the first extreme, the first axis is substantially arranged coplanar or close to the plane of the front opening: this configuration corresponds to the closing and opening positions of the leaves. At the second extreme, the axis is spaced orthogonally from the plane of the front opening: to this configuration there corresponds an intermediate position of the leaves.

Preferably the furniture item comprises means for rotating the second leaf with respect to the first leaf about the second hinging axis during the displacement of the leaves towards the second position. In particular, the means are configured so that the aforesaid rotation is gradual and synchronized with the translatory movement of one or each leaf. E.g. the furniture item comprises means for rotating the second leaf towards/away from the first leaf about the second hinging axis during the displacement of the leaves towards the second/first position.

Preferably, the translatable control element comprises a vertical wall mounted translatable on—and with respect to—the compartment to slide substantially parallel to the direction that identifies the depth of the compartment. More preferably, the translatable control element comprises two vertical walls arranged orthogonally to each other and movably mounted on—and with respect to—the compartment. In a first variant, the two vertical walls are arranged as an L-shape and mounted movably on the—and with respect to—the compartment for delimiting a second compartment or closet in which the leaves, when packed, are stored. In a second variant, the two vertical walls are arranged as a T-shape and are mounted on—and with respect to—the compartment to close a second compartment or closet in which the leaves, when packed, are stored. This allows covering the leaves when they are not in use, protecting them from dust and protecting their mechanisms from accidental impact.

It should be noted that said movably mounted body in some preferred variants implements return means for exerting a force on the translatable control element. The weight of said movably mounted body is acting to move the translatable command element to e.g. the rest position, i.e. the first extreme. So a user just needs to pull the translatable control element towards himself to move it from the first to the second extreme, and the translatable control element will return automatically in position when released because it is pulled by the weight of said movably mounted body while sliding on the inclined guide or guides.

Preferably, the two parallel guides are integral with the furniture frame and are arranged along the direction of the depth of the furniture item.

Preferably, the translatable control element is an aluminum frame.

The advantages of the invention will be even clearer from the following description of preferred embodiments of furniture item, referring to the attached drawing in which

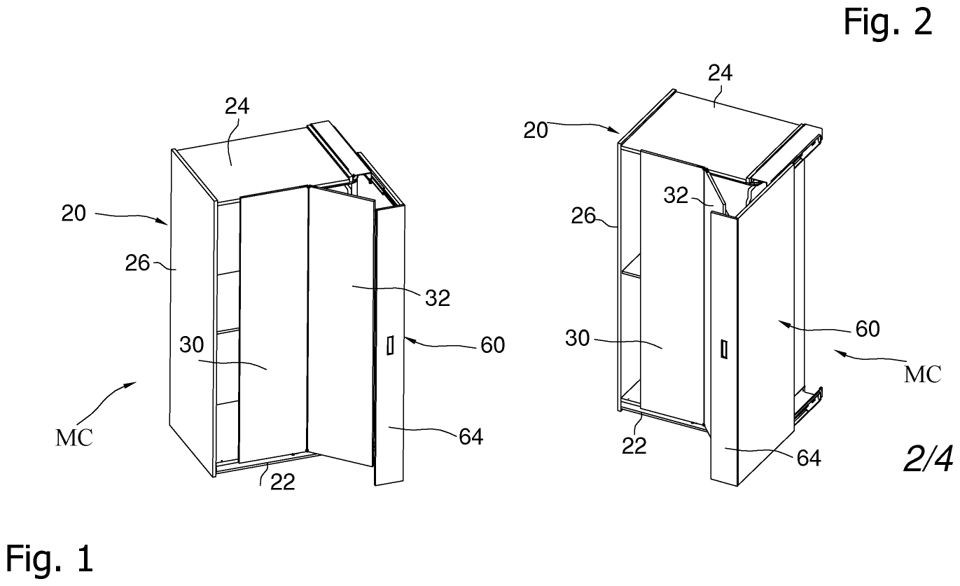

FIGS. 1-2 show frontal three-dimensional views of furniture item;

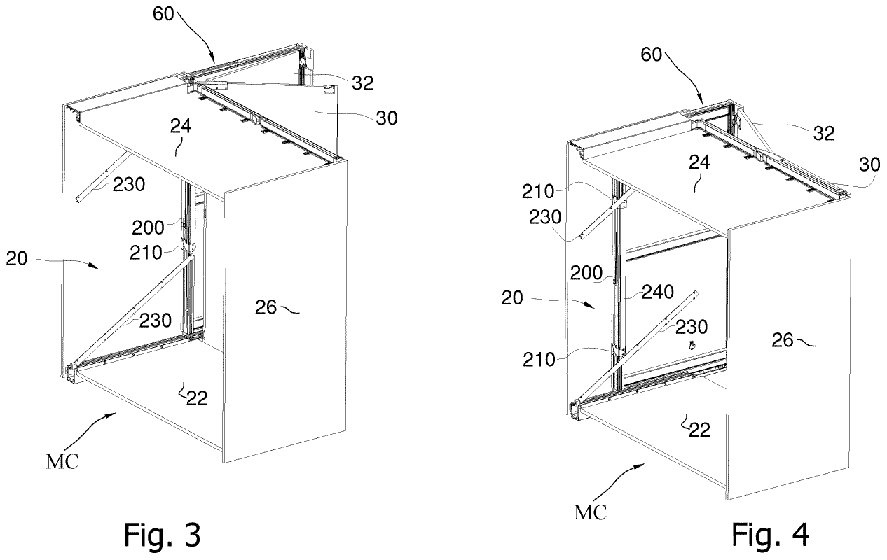

FIGS. 3-4 show rear three-dimensional views of the furniture item of FIG. 1.

In the figures equal numbers indicate equal or conceptually similar parts, and the elements are described as in use.

A furniture item MC according to the invention comprises a module formed by a compartment 20 which defines a space open toward the outside delimited by a bottom 22, a ceiling 24, two vertical side walls 26 spaced from each other as the width of the compartment 20 and a rear wall 28. The compartment 20 forms a front span that can be covered by two leaves 30, 32 slidable in front of the compartment 20. The leaves 30, 32 can move like a bellows in front of the compartment 20 to close it or to leave it accessible from the outside. During the movement the leaves 30, 32 always remain vertical and vary their relative position and that with respect to compartment 20. When the compartment 20 is closed, the leaves 30, 32 are adjacent and coplanar to each other, while to uncover the compartment 20 the leaves 30, 32 are movable to pack themselves one over the other on one side of the compartment 20.

The structure of the displacement mechanism for the leaves 30, 32 is not essential, and may be e.g. that described in WO2019012435.

The furniture item MC preferably comprises a movable frame or flank or element 60, which is linearly translatable along a direction parallel to the wall 26 (or in other words, parallel to the segment 54 or orthogonal to the wall 28). The movable frame or side or element 60 is linearly translatable e.g. through linear guides mounted on the side of the compartment or other known means, e.g. via skids.

The leaves 30, 32 can then be moved in front of the compartment 20 by actuating the element 60, which avoids moving the leaves 30, 32 by hand in a difficult way or by other means. The coupling between the leaf 32 and the element 60 is advantageous because the user only needs to move the element 60 back and forth (e.g. via a handle) to move the leaves 30, 32 together, from coplanar to packed and hidden, or vice versa.

The element 60 can be moved back and forth parallel to the vertical wall 26, so that its front wall 64 rests on the front edge of the wall 26 to end up coplanar with the leaves 30, 32 when the compartment 20 is closed by them.

To start the movement of the leaves 30, 32, a traction of the element 60 is sufficient to extract it from the furniture item MC (motion towards the user, i.e. moving away from the rear wall 28). This displacement of the element 60 gives the leaf 30, through the leaf 32, an impulse that sets it in motion.

The furniture item MC comprises a return means for the element 60 to return the element 60 towards the wall 28. In this way the user is only required to pull towards himself the element 60; after which the element 60 can be released and will end its stroke, together with the leaves 30, 32, operated by the return means.

The control element 60 is integral with a vertical guide 200 in which are linearly slidable two skids 210. Each skid 210 is rigidly constrained to the other skid, e.g. via a bar 240, and is slidably constrained to a respective inclined straight bar 230 integral with the furniture frame and e.g. mounted outside the side 26. The two bars 230 are parallel, spaced apart from each other and inclined with respect to the horizon.

The bar 240 is horizontally slidable without detachment along the bars 230, and simultaneously slidable vertically on the guide 200 thanks to the skids 210.

When the element 60 moves back and forth to move the leaves 30, 32, the skids 210 slide along the bars 230, and consequently go up and down in unison along the guide 200. In this way the movement of the element 60 gets stabilized to avoid jamming or vibrations.

The weight of the bar 240 (and/or of all or some of the components integral with it) is designed so that the force of gravity alone acting on it is sufficient to drag the bar 240 and the skids 210 downwards, i.e. towards the lower end of the bars 230, together with the element 60. To this extreme there corresponds a rest position relative to one or each of the end-of-travel positions of the element 60, i.e. when it is inserted inside the furniture's frame or completely extracted from the frame.

In this way there constantly exists a return force on the element 60, constituted by the force of gravity that attracts downwards the bar 240 (and/or all or some of the components integral with it) along the guides 230.

It is clear that the return force is produced in a simple way, with few parts, without energy consumption and with almost constant intensity.

1. Method for building a furniture item that—in use—comprises
a leaf,
a linear downwards-inclined guide, and
a body slidably mounted on the guide and connected to the leaf to drag it to an end-of-travel position,
wherein said body moves on the guide to drag the leaf only thanks to the force of gravity.

2. Furniture item comprising in use:
a leaf which is slidable and swinging to close a compartment,
a linear downwards-inclined guide;
a body slidably mounted on the guide and connected to the leaf to drag it to an end-of-travel position;
wherein said body is configured to be able to move on the guide to drag the leaf towards an end-of-travel position only thanks to the force of gravity.

3. Furniture item according to claim 2, wherein the body is slidably mounted on two parallel and downwards-inclined guides.

4. Furniture item according to claim 1, wherein the body is slidably mounted on the guide—or on the parallel guides—by means of skids.

5. Furniture item according to claim 1, comprising:
an L-shaped guide comprising two linear segments connected to each other, wherein a first segment is parallel to an edge of the opening of a compartment of the furniture, and a second segment is orthogonal to the first segment and arranged at an outer side of the compartment along the depth of the compartment;
a control element which can be translated parallel to—and along—said outer side;
wherein a side edge of the leaf is slidingly coupled to the L-shaped guide, and
the opposite side edge of the leaf is swingingly connected to the control element so that a reciprocating linear motion of the latter moves the leaf to a first position in which it closes the compartment or to a second position in which the leaf clears the compartment and is placed side by side with said outer side, wherein
the control element coincides with the aforementioned slidably mounted body or the control element is connected to the aforementioned slidably mounted body in order to be moved and displace the leaf towards the first or second position.

6. Furniture item according to claim 1, comprising a first leaf as defined above and a second leaf connected to the first leaf in an oscillating manner,
the first leaf, at its side closest to the second segment, being slidably coupled to the L-shaped guide, and
a side of the first leaf being hinged to the movable control element about a first axis,
the opposite side of the first leaf being slidably coupled to the L-shaped guide about a second axis.
